(19) United States
(12) Patent Application Publication
(10) Pub. No.: US 2006/0038966 A1
(43) Pub. Date: Feb. 23, 2006

(54) Apodizing filter

(76) Inventors: Michael D. Long, Corvallis, OR (US); Peter Guy Howard, Junction City, OR (US); Anurag Gupta, Corvallis, OR (US); David L. Erickson, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/985,432

(22) Filed: Nov. 10, 2004

Related U.S. Application Data
(60) Provisional application No. 60/603,499, filed on Aug. 20, 2004.

(51) Int. Cl. G03B 21/14

(52) U.S. Cl. 353/97

(57) ABSTRACT

One embodiment of a projector may include a light source that emits light and a gradient profile filter positioned to filter light emitted from the light source.

### BACKGROUND

Stray light that enters a projection lens may be undesirable. The stray light may tend to be outside a central portion of the lens while the desirable light may be confined to the central portion of the lens. A filter may be used to cut down on this stray light that passes through an edge region of the filter. In particular, an apodizing filter, i.e., a filter having an uncrisp edge, may be used to block light in an edge region of the filter. There are several types of apodizing filters. One type of apodizing filter is a mechanically adjustable iris, much like a camera shutter having overlapping leaves. This mechanical shutter type filter may not provide a satisfactory gradient profile due to the opaqueness of each of the shutter leaves. Another type of apodizing filter may comprise light blocking material deposited on a substrate by vapor deposition techniques using a mask to provide the gradient profile. This technique may provide apodizing filters that function satisfactorily when a circularly symmetrical mask is used. However, vapor deposition techniques are not well suited for the manufacture of a gradient profile having a non-circular shape.

### BRIEF DESCRIPTION OF THE DRAWINGS

FIG. 1 is a schematic of one embodiment of a projector including one embodiment of an apodizing filter.

FIG. 2 is a perspective view of one embodiment of an untreated glass substrate 20 that may be utilized for the manufacture of an apodizing filter.

FIG. 3 is a perspective view of one embodiment of a grey scale, circular apodizing filter on one embodiment of a substrate.

FIG. 4 is a perspective view of one embodiment of a grey scale, square apodizing filter on one embodiment of a substrate.

FIG. 5 is a graph showing one embodiment of stepped light blocking characteristics versus a distance from the center of one embodiment of a filter, taken along line 5-5 of FIG. 4.

FIG. 6 is a perspective view of one embodiment of a gradient deposition, square apodizing filter on one embodiment of a glass substrate.

FIG. 7 is a graph showing one embodiment of substantially smooth gradient light blocking characteristics versus a distance from the center of one embodiment of a filter, taken along line 7-7 of FIG. 6.

FIGS. 8A-D are plan views, respectively, of three embodiments of a substrate, and one embodiment of an apodizing filter created from the three substrates.

FIGS. 9A-D are plan views, respectively, of three embodiments of a substrate having successive layers of light blocking material deposited thereon, and one embodiment of an apodizing filter created from the three layers.

FIGS. 10A-D are plan views, respectively, of three embodiments of screens each having a different mesh orientation, and one embodiment of an apodizing filter created from a stacked arrangement of the three screens.

FIGS. 11A and B are plan views of embodiments of a dynamically activated apodizing filter 170 utilizing a liquid crystal display 172.

FIG. 12A-12E show liquid crystal displays 172 having different shaped regions (demarcated by dash lines) that may each define different pixel activation densities.

FIG. 13 is a schematic showing one embodiment of a silk screen printing apparatus to manufacture one embodiment of an apodizing filter.

FIG. 14 is a schematic showing one embodiment of an inkjet printing apparatus to manufacture one embodiment of an apodizing filter.

FIG. 15 is a flow chart of one embodiment of a method of creating an apodizing filter.

FIG. 16 is a flow chart of one embodiment of a method of creating an apodizing filter.

### DETAILED DESCRIPTION OF THE DRAWINGS

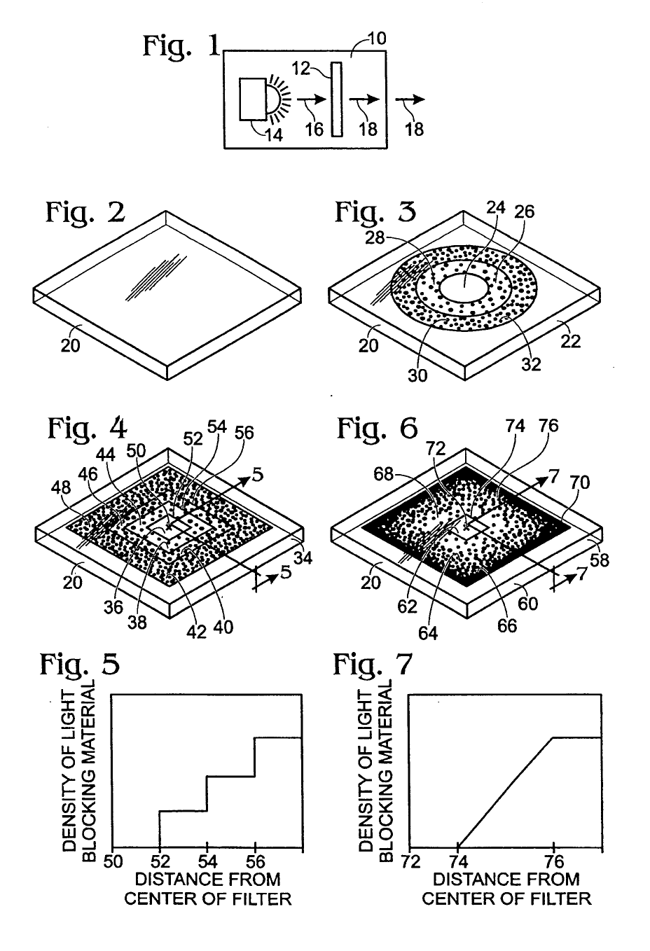

FIG. 1 is a schematic of one embodiment of a projector 10 including one embodiment of an apodizing filter 12. For purposes of this application, “apodizing filter” means a filter having an uncrisp edge. In other words, an apodizing filter may have a transparent central region through which light may pass substantially unblocked, and a substantially smooth gradient profile, or a stepped grey scale profile, of light blocking material that increases outwardly from the central region such that some light is blocked in a transition region of the filter and substantially all light is blocked in an edge region of the filter. Filter 12 may be positioned generally adjacent a light source or adjacent a light modulator 14 such that light 16 emitted from or through light modulator 14 will pass through filter 12 to produce filtered light 18 wherein filter 12 may block stray light from passing through an edge region thereof. Filtered light 18 may be emitted from projector 10 for use in a variety of applications.

FIG. 2 is a perspective view of one embodiment of an untreated substrate 20, such as a glass substrate, upon which light blocking material may be placed so as to create filter 12.

FIG. 3 is a perspective view of one embodiment of a grey scale, circular shaped apodizing filter 22 on one embodiment of a substrate 20. Filter 22 may include a circularly shaped central region 24 having an absence of light blocking material therein such that central region 24 is substantially transparent and allows substantially all light emitted to central region 24 to pass therethrough.

Filter 22 may further include a circularly shaped middle or transition region 26 that may include a light blocking material 28 therein. Light blocking material 28 may have a density such that some light is blocked but some light is passed therethrough such that the light blocking characteristics of transition region 26 may be greater than the light blocking characteristics of central region 24. In one example, transition region 26 may allow more than fifty percent and up to one hundred percent of light emitted to transition region 26 to pass therethrough. Of course, any range of density of light blocking material 28 may be provided in transition region 26.

Filter 22 may further include a circularly shaped outer or edge region 30 that may include a light blocking material 32 therein. Light blocking material 32 may have a density such that some light is blocked but some light is passed therethrough such that the light blocking characteristics of edge region 30 may be greater than the light blocking characteristics of transition region 26. In one example, edge region 30 may allow from zero percent up to fifty percent of light emitted to edge region 30 to pass therethrough. Of course, any range of density of light blocking material 32 may be provided in edge region 30. Light blocking material 32 may be different from or the same as light blocking material 28 of transition region 26. Accordingly, a stepped light blocking gradient may be created by each of regions 24, 26 and 30, such that the light blocking characteristics of filter 22 may not increase smoothly but may increase in stepped increments between regions 24 and 26 and between region 26 and 30.

In an embodiment wherein light blocking material 32 of edge region 30 is the same material as light blocking material 28 of transition region 26, the density or amount of material in edge region 30 may be greater than the density or amount of light blocking material in transition region 26 so as to provide the desired light blocking characteristics of each region. In other embodiments, other numbers of regions may be utilized to create filter 22, wherein each successively outwardly positioned region may provide greater light blocking characteristics than its adjacent inwardly positioned region.

Light blocking material 28 and 32 of regions 26 and 30, respectively, may be deposited by silk screen printing or inkjet deposition techniques, as will be described below. These silk screening and inkjet deposition techniques may allow deposition of the light blocking material in any desired shape and having any gradient profile.

FIG. 4 is a perspective view of one embodiment of a grey scale, square shaped apodizing filter 34 on one embodiment of a substrate 20, such as a glass or a plastic substrate. Filter 34 may comprise a central region 36, a first transition region 38, a second transition region 40, and an edge region 42, where each of regions 38, 40 and 42 may have a light blocking material 44, 46 and 48, respectively, deposited therein. Light blocking material 48 may have a density, for example, a number of light blocking particles, greater than light blocking material 46 such that edge region 42 may block more light from passing therethrough when compared to second transition region 40. Similarly, light blocking material 46 may have a density greater than light blocking material 44 such that second transition region 40 may block more light from passing therethrough when compared to first transition region 38.

FIG. 5 is a graph showing light blocking characteristics of filter 34 versus a distance from a center 50 of filter 34, taken along line 5-5 of FIG. 4. The amount of light blocked by the light blocking material, which may correspond directly to a density of the light blocking material, for the particular embodiment shown may be seen to increase in steps at positions 52, 54 and 56, which may correspond to, respectively, the transition between regions 36 and 38, the transition between regions 38 and 40, and the transition between regions 40 and 42.

FIG. 6 is a perspective view of one embodiment of a gradient deposition, square apodizing filter 58 on one embodiment of a substrate 60, such as a transparent plastic substrate. Filter 58 may include a square shaped central region 62, a transition region 64 and an edge region 66. Central region 62 may be substantially transparent and may include no light blocking material therein. Transition region 64 may include a smooth gradient profile of light blocking material 68 and edge region 66 may include a density of light blocking material 70 greater than a density of the light blocking material in an outermost portion of transition region 64. “Smooth gradient profile” may be defined as a density of light blocking material 68 that increases smoothly within transition region 64 from a lesser amount at an inner portion of transition region 64 to an outer region of transition region 64. “Smooth gradient profile” may also be defined as a light blocking characteristic that increases smoothly within transition region 64 from a lesser amount at an inner portion of transition region 64 to an outer region of transition region 64.

Light blocking material 68 and 70 of regions 64 and 66, respectively, may be deposited by silk screen printing or inkjet deposition techniques, as will be described below. These silk screening and inkjet deposition techniques may allow deposition of the light blocking material in any desired shape and having any gradient profile.

FIG. 7 is a graph showing a one embodiment of light blocking characteristics versus a distance from a center 72 of one embodiment of filter 58, taken along line 7-7 of FIG. 6. The amount of light blocked by the light blocking material, which may correspond directly to the density of light blocking material, for the particular embodiment shown may be seen to increase smoothly from position 74 to position 76, which may correspond to, respectively, the transition between regions 62 and 64, and the transition between regions 64 and 66.

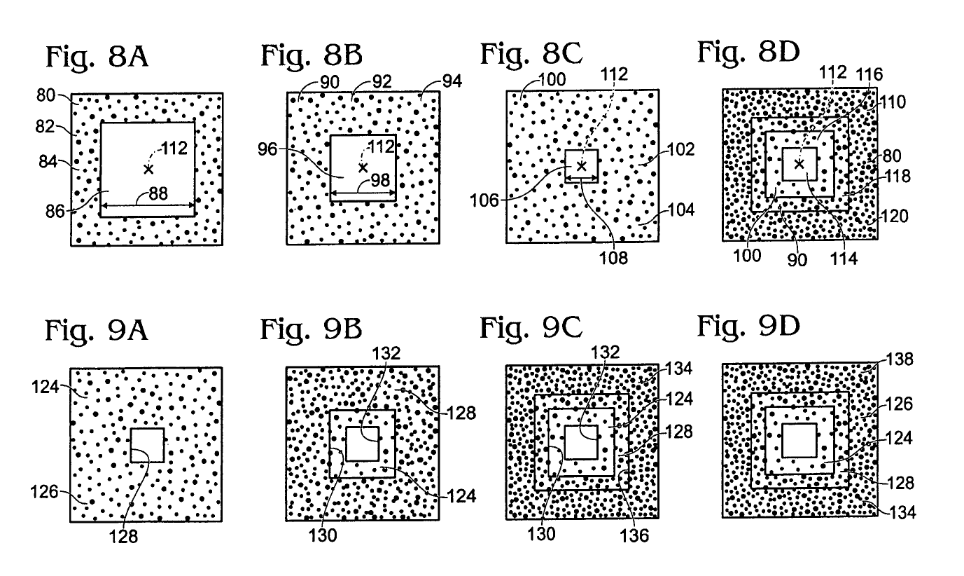

FIGS. 8A-D are plan views, respectively, of three embodiments of a substrate, and one embodiment of an apodizing filter created from the three substrates. FIG. 8A shows a substrate 80 having a light blocking material 82 deposited in a region 84 that surrounds a transparent square shaped central region 86. Central region 86 has a unique size, namely, a width 88. FIG. 8B shows a substrate 90 having a light blocking material 92 deposited in a region 94 that surrounds a transparent square shaped central region 96. Central region 96 has a unique size, namely, a width 98. FIG. 8C shows a substrate 100 having a light blocking material 102 deposited in a region 104 that surrounds a transparent square shaped central region 106. Central region 106 has a unique size, namely, a width 108. FIG. 8D shows an apodizing filter 110 that is manufactured by placing each of substrates 80, 90 and 100 adjacent one another such that each of central regions 86, 96, and 106 are centrally aligned along a central axis 112.

The term “unique size” may be defined in that the size of a particular structural element may be different than a size of a corresponding structural element within an apodizing filter. For example, each of central regions 86, 96 and 106 of substrates 80, 90 and 100, respectively, may have a unique size, i.e., a width sized differently than the width sizes of the other central regions. Accordingly, when substrates 80, 90 and 100 are positioned adjacent one another a central region 114 will have no light blocking material therein, a first transition region 116 will have one layer of light blocking material therein, a second transition region 118 will have two layers of light blocking material therein, and an edge region 120 will have three layers of light blocking material therein. The amount of light blocked by the individual regions may be directly related to the thickness, or the number of layers, of the light blocking material. Accordingly, apodizing filter 110 may have a stepped gradient profile of light blocking material, and therefore may have a stepped gradient profile of light that may be transmitted therethrough, similar to the profile shown in FIG. 5.

Light blocking material 82, 92 and 102 may be deposited on substrates 80, 90 and 100, respectively, by a silk screening process, an inkjet printing process, or the like. In the silk screening process, the screen utilized to create light blocking material 82 may have an opaque region that corresponds to central region 86 such that substantially no light blocking material is deposited in central region 86. The screen utilized to create light blocking material 92 may have an opaque region that corresponds to central region 96 such that substantially no light blocking material is deposited in central region 96. The screen utilized to create light blocking material 102 may have an opaque region that corresponds to central region 106 such that substantially no light blocking material is deposited in central region 106.

The light blocking material itself may comprise a pigmented material, a dye, or any other material that may function to block or partially block light from passing therethrough, and which may be applied on a substrate or on a previously deposited layer.

FIGS. 9A-D are plan views, respectively, of three embodiments of a substrate having successive layers of light blocking material deposited thereon, and one embodiment of an apodizing filter created from the three layers. The layers may be deposited by silk screening, inkjet printing, or the like. FIG. 9A shows a first layer 124 deposited on a substrate 126. FIG. 9B shows a second layer 128 deposited on layer 124 and having a larger central region 130 than the central region 132 of first layer 124. FIG. 9C shows a third layer 134 deposited on second layer 128 and having a larger central region 136 than the central region 130 of second layer 128. FIG. 9D shows an apodizing filter 138 that may comprise substrate 126 having three layers 124, 128 and 134 deposited thereon. Filter 138 may have light blocking material, and light blocking characteristics, similar to that shown in FIG. 5.

Light blocking layers 124, 128 and 134 may be deposited on substrate 126 by a silk screening process, an inkjet printing process, or the like. In the silk screening process, the screen utilized to create light blocking layer 124 may have an opaque region that corresponds to central region 132 such that substantially no light blocking material is deposited in central region 132. The screen utilized to create light blocking layer 128 may have an opaque region that corresponds to central region 130 such that substantially no light blocking material is deposited in central region 130. The screen utilized to create light blocking layer 134 may have an opaque region that corresponds to central region 136 such that substantially no light blocking material is deposited in central region 136. In another embodiment the filter may include a stepped function of light blocking material wherein each region of the stepped function may include a gradient profile. In other words, one embodiment may include a combination of stepped gradients and smooth gradients of light blocking material.

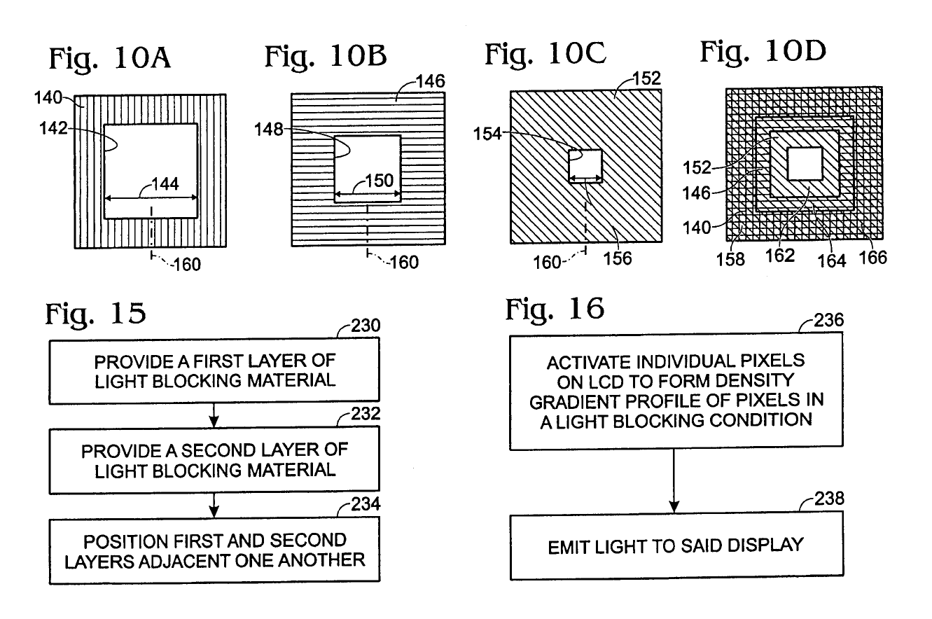

FIGS. 10A-D are plan views, respectively, of three embodiments of screens each having a different embodiment of a mesh orientation, and an apodizing filter created from a stacked arrangement of the three screens. FIG. 10A shows a screen 140, such as a wire mesh screen, with an aperture 142 having a width 144. Screen 140 has a wire orientation of zero degrees, i.e., zero degrees from a vertical axis 160. FIG. 10B shows a screen 146, such as a wire mesh screen, with an aperture 148 having a width 150. Screen 146 has a wire orientation of ninety degrees, i.e., ninety degrees from vertical axis 160. FIG. 10C shows a screen 152, such as a wire mesh screen, with an aperture 154 having a width 156. Screen 152 has a wire orientation of forty five degrees, i.e., forty five degrees from vertical axis 160. Each of apertures 142, 148 and 154 have a different sized, or unique sized, width 144, 150 and 156, respectively.

FIG. 10D shows an apodizing filter 158 created by stacking screens 140, 146 and 152 adjacent one another. The mesh of the screens may block or partially block light from passing therethrough. The three different orientations of the mesh in a stacked arrangement, therefore, may result in more light blocking characteristics in the regions where there is a greater density of mesh material. In other words, region 162 having one layer of mesh may have a relatively low light blocking characteristic, such as blocking less than ten percent of the light emitted to the mesh. Region 164 having two layers of mesh may have a medium light blocking characteristic, such as blocking more than ten percent and less than fifty percent of the light emitted to the mesh. Region 166 having three layers of mesh may have a high light blocking characteristic, such as blocking more than fifty percent and up to one hundred percent of the light emitted to the mesh. Of course any percentage ranges of light blocking characteristics of the mesh may be utilized, such as by adjusting the width of the individual wires of each mesh, the spacing between the individual wires of each mesh, and the orientation of the mesh with respect to a predetermined axis. In other embodiments the stacked layers may not be aligned along a central axis and may not be positioned adjacent one another but may be spaced from one another along the light path.

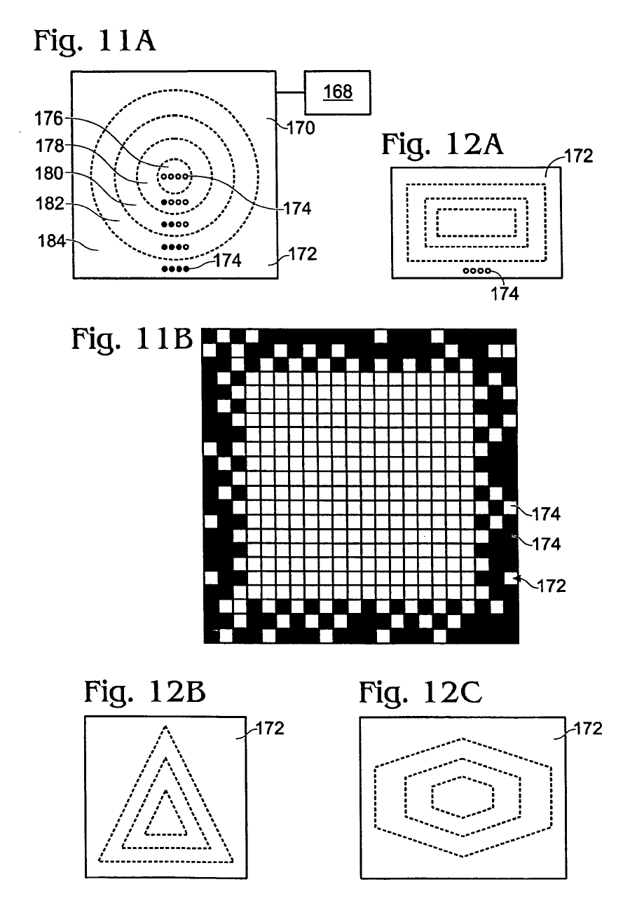

FIG. 11A is a plan view of one embodiment of a dynamically activated apodizing filter 170 utilizing a liquid crystal display 172. Display 172 may include a plurality of pixels 174, such as several thousand pixels 174 (for purposes of illustration, only a few pixels are shown and the pixels are shown as much larger than they may actually exist on a liquid crystal display). As will be understood by those skilled in the art, liquid crystal display 172 may comprise an optically transparent “sandwich” of panels having an opaque backing. The inner faces of the two panels may make up the sandwich may contain a thin metallic film. On one of the panels, such as the front panel, a film may have been deposited in the form of a desired display, such a plurality of individually controllable pixels 174, covering the entire panel. On the other one of the panels, such as the back panel, a film may have been deposited covering the entire panel. Between the two panels may be a nematic liquid which ordinarily may be transparent. When an electrical field may be passed between the back metallized panel and one of the pixels on the front panel, the liquid between these portions of the panels may darken and become opaque. That particular pixel may appear as a black mark and may block light from passing therethrough. When the electrical field is removed from the particular pixel, the liquid may become transparent again, thereby allowing light to pass therethrough.

Each of the individual pixels on display 172 may be dynamically activated or deactivated, i.e., may be activated or deactivated for any time period, independently of the other pixels on display 172. Accordingly, each of pixels 174 of display 172 may be individually activated between an on condition and an off condition by a controller 168 (shown schematically), such as a computer. In the embodiment shown, the individual pixels 174 may allow the passage of light therethrough when the pixel is in an off condition, i.e., when the pixel is light, and may block the passage of light therethrough when the pixel is in an on condition, i.e., when the pixel is dark. In another embodiment, individual pixels 174 may allow the passage of light therethrough when the pixel is in an on condition and may block the passage of light therethrough when the pixel is in an off condition. Accordingly, in an embodiment including many pixels, a density gradient of activated pixels may be controlled within display 172 by controlling each of the individual pixels 174. For example, in a first oval region 176 of display 172 (wherein the region of pixels is shown as delineated by a dash line), no pixels 174 may be activated to an on condition (wherein the on condition is represented by a black pixel and an off condition is represented by a white pixel). In a second oval region 178, one of every four pixels 174 may be activated to an on condition. In a third oval region 180, two of every four pixels may be activated to an on condition. In a fourth oval region 182, three of every four pixels may be activated to an on condition. In a fifth oval region 184, four of every four pixels may be activated to an on condition. (Only four pixels are shown in each region for ease of illustration). Accordingly, display 172 may define a density gradient of light passage characteristics such that in first region 176 approximately all light that is emitted to the filter is passed therethrough; in second region 178 approximately eighty percent of all light that is emitted to the filter is passed therethrough; in third region 180 approximately fifty percent of all light that is emitted to the filter is passed therethrough; in fourth region 182 approximately twenty percent of all light that is emitted to the filter is passed therethrough; and, in fifth region 184 approximately no light that is emitted to the filter is passed therethrough. Accordingly, display 172 may have a light blocking gradient characteristic similar to that shown in FIG. 7.

FIG. 11B shows another embodiment of a display 172 wherein ones of individual pixels 174 are activated (seen as black or opaque pixels) and different ones of individual pixels 174 are not activated (seen as white or transparent pixels). In another embodiment, individual pixels 174 may be turned to a grey state, i.e., partially on and partially off, so as to partially block light from passing therethrough. In the embodiment shown, liquid crystal display pixels 174 may be much smaller in size than the size of a pixel from an optical modulator, i.e., an electronic imaging plane, so that each optical modulator pixel may include three or more liquid crystal display pixels 174. Such small sized display pixels 174 may allow for a smooth gradient of light transmitting or blocking characteristics on an electronic imaging plane.

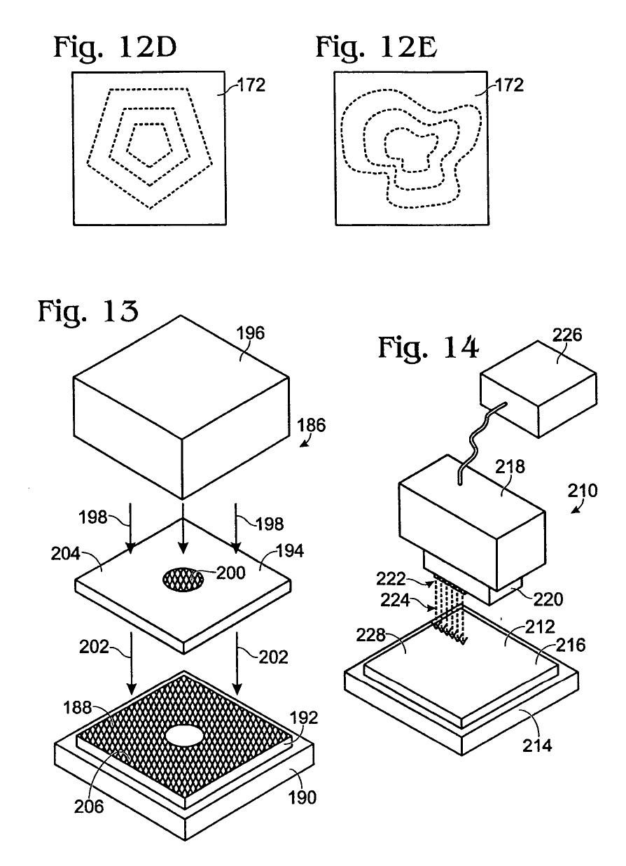

FIG. 12A-12E show liquid crystal displays 172 having different shaped regions (demarcated by dash lines) that may each define different pixel activation densities. FIG. 12A shows a set of rectangular shaped pixel activation density regions. FIG. 12B shows a set of triangular shaped pixel activation density regions. FIG. 12C shows a set of hexagon shaped pixel activation density regions. FIG. 12D shows a set of pentagon shaped pixel activation density regions. FIG. 12E shows a set of abstract shaped pixel activation density regions.

Manufacture of the filter will now be described.

FIG. 13 is a perspective exploded view of one embodiment of a silk screen printing apparatus 186 that may be utilized to manufacture one embodiment of an apodizing filter 188. Silk screen printing apparatus 186 may include a base or table 190 for supporting a substrate 192, a screen 194, which may be manufactured of small silk threads, positioned adjacent base 190 such as directly on the base (in this exploded view screen 194 is positioned high above substrate 192 so that the substrate can be viewed), and a deposition apparatus 196 (shown schematically), such as a tank or a hand held wiper, for depositing a light blocking material 198 onto screen 194. Screen 194 may include a masked region 200 that may reduce or inhibit an amount of light blocking material that may pass through screen 194 within region 200 such that light blocking material 202 may only substantially be passed through screen 194 in a region 204. Accordingly, region 204 may correspond to a region 206 on substrate 192 that may receive light blocking material 202. Additionally, region 200 may correspond to a region 208 on substrate 192 that may receive substantially no light blocking material 202. A variety of screens 194 may be utilized to print a succession of substrates with light blocking material in a predetermined region having a unique size and/or shape, or to print on a single substrate a succession of layers with light blocking material in a predetermined size and/or shape within each layer. In this manner, multiple layers of unique patterns of light blocking material may be stacked so as to define an apodizing filter having a gradient or a stepped profile of light blocking material thereon.

FIG. 14 is a schematic showing one embodiment of an inkjet printing apparatus 210 that may be utilized to manufacture one embodiment of an apodizing filter 212. Inkjet printing apparatus 210 may include a base 214 for supporting a substrate 216 thereon. Apparatus 210 may further include a print carriage 218 that may movably support a printhead 220 thereon. Printhead 220 may include a plurality of nozzles 222 (for ease of illustration, only a few nozzles are shown and the nozzles are shown extending outwardly from printhead 220 so they may be viewed in this figure) that may eject a light blocking material 224, such as ink, therefrom. Printhead 220 may be controlled by a controller 226, such as a computer, such that printhead 220 may be moved over substrate 216 and may be activated to eject ink 224 in a predetermined pattern and in a predetermined density on substrate 216. Nozzles 222 may be small compared to a size of substrate 216 such that the pattern and density of ink ejected onto substrate 216 may be finely controlled. Once the ejected pattern and density of ink 224 is deposited on substrate 216, the ink may be allowed to dry to form a light blocking coating 228 on the substrate. Multiple layers of coating may be applied by nozzles 222 by allowing successive layers to dry between each coating process.

FIG. 15 is a flow chart of one embodiment of a method of creating an apodizing filter. A first step 230 may comprise providing a first layer of a light blocking material having a first pattern. A second step 232 may comprise providing a second layer of a light blocking material having a second pattern. A third step 234 may comprise positioning the first layer adjacent the second layer to form an apodizing filter having a density profile of light blocking material thereon. In one embodiment the first pattern may comprise a central region having a first size, wherein light blocking material may not be present in the central region but may be present in the remainder of the layer. The second pattern may comprise a central region having a second size different from the first size, wherein light blocking material may not be present in the central region but may be present in the remainder of the layer. When the layers are positioned adjacent one another, the difference in size of the first and second central regions may define a gradient or a stepped density profile so as to create an uncrisp edge around a region through which light is passed. In other embodiments, other layers may be added. The layers may comprise successive layers on one or more substrates, or may comprise a single layer on each of multiple substrates that subsequently may be stacked together.

FIG. 16 is a flow chart of one embodiment of a method of creating an apodizing filter. A first step 236 may comprise activating individual pixels in a liquid crystal display so as to define a density gradient profile of pixels having a light blocking characteristic. A second step 238 may comprise emitting light to said display such that at least some light in an outer region of the display is blocked.

Other variations and modifications of the concepts described herein may be utilized and fall within the scope of the claims below.

We claim:

1. An apodizing filter, comprising:
a liquid crystal display including a plurality of electronically activated pixels, each of said pixels adapted to be individually activated between an on condition and an off condition, wherein said pixels are activated so as to define a density gradient of activated pixels that increases outwardly toward an edge region of said display.

2. An apodizing filer according to claim 1 wherein said display includes a central region, an edge region, and a transition region positioned therebetween, and wherein no pixels are activated in said central region, less than half of said pixels in said transition region are activated, and more than half of said pixels in said edge region are activated.

3. An apodizing filter according to claim 1 wherein said pixels in the activated state substantially block light from passing therethrough.

4. An apodizing filter according to claim 2 wherein said central region defines a shape chosen from one of a square, a rectangle, a triangle, a hexagon, an oval, a pentagon, and an abstract shape.

5. A projector, comprising:
a lens; and
a liquid crystal display including a plurality of individually activated pixels, said pixels each adapted to be changed between activated and non-activated states to define a variety of gradient profiles of activated pixels within said display, wherein pixels in the activated state block light from passing through said lens.

6. A projector according to claim 5 wherein one of said gradient profiles increases in density toward an outer region of said filter.

7. A projector according to claim 5 wherein one of said gradient profiles comprises a translucent central region having a shape chosen from one of a square, a rectangle, a triangle, a hexagon, an oval, a pentagon, and an abstract shape.

8. A projector, comprising:
a light source that emits light; and
a gradient profile filter positioned to filter light emitted from said light source.

9. A projector according to claim 8 wherein said gradient profile is chosen from one of a dynamic gradient profile generated by a liquid crystal display and a fixed gradient profile.

10. A method of dynamically creating a filter having a gradient profile, comprising:
activating a plurality of pixels on a liquid crystal display such that a density of activated pixels increases outwardly from a central region of said display toward an edge region of said display.

11. A method according to claim 10 wherein said density of activated pixels is zero percent pixel activation in said central region, said density of activated pixels is greater than ninety percent pixel activation in said edge region, and a density of activated pixels in a transition region position between said central region and said edge region is greater than zero and less than ninety percent pixel activation.

12. A method according to claim 10 wherein said pixels, when activated, substantially block light from passing therethrough.

13. A method according to claim 10 wherein said central region defines a non-circular shape.

14. A method according to claim 10 wherein said activating comprises creating a density gradient profile of activated pixels in a first shape on said display, said method further comprising:
activating said plurality of pixels on said liquid crystal display so as to create a density gradient profile of activated pixels in a second shape on said display wherein said second shape is different from said first shape.

15. A method according to claim 14 wherein said first and second shapes are each chosen from one of a square, a rectangle, a triangle, a hexagon, an oval, a pentagon, and an abstract shape.

16. A method according to claim 10 wherein said activating is conducted by a controller.

17. A projector, comprising:
a light source that defines a light path, and
a filter positioned within said light path and including a fixed gradient transmission profile.

18. A projector according to claim 17 wherein said filter comprises a plurality of layers on a substrate, each layer having a transparent central region of a unique size.

19. A projector according to claim 17 wherein said filter comprises a plurality of substrates positioned adjacent one another, each substrate having a transparent central region of a unique size.

20. A projector according to claim 17 wherein said filter is manufactured by a process chosen from one of inkjet printing and silkscreen printing.

21. A projector according to claim 19 wherein said plurality of substrates comprise a plurality of meshes, each mesh having a unique orientation.

22. A projector according to claim 21 wherein said plurality of meshes comprise a first mesh having a zero degree wire orientation, a second mesh having a forty five degree wire orientation, and a third mesh having a ninety degree wire orientation.

23. A projector according to claim 22 wherein said first mesh includes a central aperture having a first size, said second mesh includes a central aperture having a second size, and said third mesh includes a central aperture having a third size, wherein said first, second and third sizes are different from one another.

24. A projector according to claim 23 wherein said first, second and third central apertures each define a substantially similar shape to one another.

25. A filter, comprising:
a substrate including:
a central region having an absence of light blocking material; and
an outer region having a fixed gradient profile of a light blocking material.

26. A filter according to claim 25 wherein said light blocking material is deposited on said substrate by one of silk screening and inkjet deposition.

27. A filter according to claim 26 wherein said substrate comprises a plurality of wire meshes, each mesh having a unique orientation and a central aperture having a unique size.

28. A filter according to claim 26 wherein said fixed gradient profile comprises a plurality of layers deposited on said substrate, each layer defining a central aperture having a unique size.

29. A filter according to claim 26 wherein said substrate comprises a plurality of sheets in a stacked arrangement, and wherein said fixed gradient profile comprises a coating of light blocking material deposited on each of said sheets, each coating defining a central aperture having a unique size.

30. A fixed gradient profile filter, comprising:
a plurality of subfilters each including a transparent central region and an outer region including a light blocking material therethroughout, each of said subfilter central regions defining an unchangeable, unique size.

31. A filter according to claim 30 wherein said subfilters each comprise a successively deposited layer of light blocking material on a transparent substrate.

32. A filter according to claim 30 wherein said subfilters each comprise a substrate having a layer of light blocking material deposited thereon, said substrates positioned adjacent one another to define a stack.

33. A filter according to claim 30 wherein said subfilters each comprise a wire mesh, said meshes positioned adjacent one another to define a stack.

34. A filter, comprising:
first means for blocking light transmission therethrough and including a first transparent central region, and
second means for blocking light transmission therethrough and including a second transparent central region, wherein said first transparent central region defines a size different from a size of said second transparent central region.

35. A filter according to claim 34 wherein said first and second means for blocking light transmission each comprises a coating deposited by one of inkjet deposition and silkscreen printing.

36. A filter according to claim 34 wherein said first and second means for blocking light transmission each comprises a wire mesh having a unique wire orientation.

37. A filter according to claim 34 wherein said first and second means each comprise a successively deposited layer on a single substrate.

38. A filter according to claim 34 wherein said first and second means each comprise a transparent substrate having a coating of light blocking material deposited thereon.

39. A method of manufacturing a fixed gradient profile filter, comprising:
providing a first light blocking layer having a substantially transparent central region with a fixed, first size;
providing a second light blocking layer having a substantially transparent central region with a fixed, second size, wherein said first size is different from said second size; and
positioning said first and second layers adjacent one another such that said transparent central regions are aligned along a central projection axis.

40. A method according to claim 39 further comprising:
providing a third light blocking layer having a substantially transparent central region with a fixed, third size, wherein said third size is different from said first and second sizes; and
positioning said first, second and third layers adjacent one another such that said transparent central regions are aligned along said central projection axis.
